(19) United States
(12) Patent Application Publication
(10) Pub. No.: US 2003/0135381 A1
(43) Pub. Date: Jul. 17, 2003

(54) Automated distributed printing system

(75) Inventors: Tim Mathiesen, Laguna Niguel, CA (US); Keith Michael Kratzberg, Irvine, CA (US); Miko Sion, Simi Valley, CA (US); Atsushi Hatta, Palos Verdes, CA (US); Hironori Matsugi, Matsumoto-shi (JP); Nobuhisa Takabayashi, Shiojiri-shi (JP); Masaru Hoshino, Suwa-shi (JP); Takao Mimura, Shiojiri-shi (JP); Shuichi Aruga, Shiojiri-shi (JP)

Correspondence Address: EPSON RESEARCH & DEVELOPMENT , INC., Intellectual Property Department, Suite 225, 150 River Oaks Parkway, San Jose, CA, 95134, US

(73) Assignee: SEIKO EPSON CORPORATION

(21) Appl. No.: 10/050,304

(22) Filed: Jan. 16, 2002

(51) Int. Cl. G06F 17/60

(52) U.S. Cl. 705/1

(57) ABSTRACT

A printing system includes a computer system to receive a digital image. A server computer, connected to the computer system, receives the digital image transmitted from the computer system. At least one printer is connected to the server computer to print the digital image. A remote monitoring server, having a connection with the server computer, monitors conditions of at least one of the server computer and the at least one printer. The remote monitoring server is operated by a lessor, and the server computer and the at least one printer are leased out to an end user under a lease agreement.

### BACKGROUND OF THE INVENTION

1. Field of the Invention

The present invention relates to an automated distributed printing system. More particularly, the present invention relates to an on-site printing system that is remotely monitored by a monitoring server operated by a service provider to track conditions of the on-site printing system. The printing system is maintained and serviced automatically by the service provider based on the conditions monitored by the monitoring server and a service/lease agreement between the service provider and the end user.

2. Discussion of the Related Art

Digital printing technology has advanced greatly in recent years. There are many high-speed printing solutions that allow users to produce a variety of professional-looking documents utilizing a personal computer. Additionally, several color printing solutions exist today that allow users to print photo-quality pictures from digital images obtained from, for example, a digital camera or a scanner.

Designers, photographers, fine art printers, and other graphics professionals, for example, may obtain all of the equipment required to produce high-quality prints from digital images. By having all of the equipment on-site, the dependence on outside photography and/or graphics laboratories is reduced. The equipment typically includes at least a computer system and a high-quality printer to print the digital images. The computer system may include software that allows a user to edit and manipulate digital images (e.g., to create special effects, crop images, change brightness and contrast, etc.). The digital images are usually provided to the computer system from another source, such as a digital camera, a scanner, another computer system, or a network connection.

High-quality color printers are expensive to own and maintain, and a typical high-quality color printer for digital images may run several thousand dollars each. Additionally, these high-quality printers need to be properly maintained in order to operate efficiently, and its consumables (i.e., print media and ink supply) must be monitored and replenished when exhausted. Often times, especially with expensive hardware devices, end users do not want to own the equipment and deal with the hassles and burden of maintaining the equipment. Moreover, along with the hassles of ownership, the upkeep of the supplies must be maintained as well, such as restocking the print media, and replacing used ink or toner cartridges.

Accordingly, there is needed for a printing solution for end users that provides automatic monitoring, maintenance, servicing, and upkeep of the printing system equipment and supplies with little or no interaction from the end user.

### BRIEF DESCRIPTION OF THE DRAWINGS

FIG. 1 illustrates a printing system solution according to an embodiment of the present invention;

FIG. 2 illustrates a flow chart diagram of printing a digital image by a printing system according to an embodiment of the present invention;

FIG. 3 illustrates a flow chart diagram of configuring a printing system according to an embodiment of the present invention; and

FIG. 4 illustrates a flow chart diagram of providing a printing system solution under a lease agreement according to an embodiment of the present invention.

### DETAILED DESCRIPTION

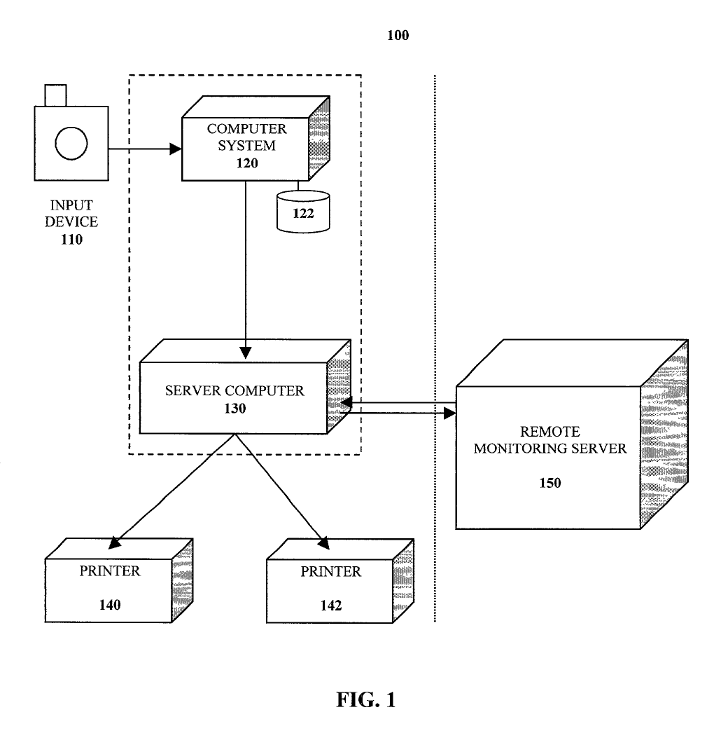

FIG. 1 illustrates a printing system solution according to an embodiment of the present invention. The printing system 100 includes a computer system 120, a server computer 130, at least one printer 140, 142, and a remote monitoring server 150. The printing system 100 allows a user to provide digital images from an input device 110 to the computer system 120. The input device 110 is preferably a digital camera, however, the input device 110 may also be a scanner, a storage medium storing digital image files, a computer system, a network (such as a local area network (LAN) or the Internet), or any other suitable device or medium that is capable of providing digital images to the computer system 120. The input device 110 may provide the digital images to the computer system 120 via a connection, for example, such as a Universal Serial Bus (USB) connection, a FireWire IEEE 1394 serial bus connection, or a network connection (e.g., 10/100 BaseT Ethernet).

The computer system 120 provides the digital images to the server computer 130, which also has connections to the at least one printer 140, 142 that prints out the digital images. The computer system 120 preferably includes a mass storage device 122, such as a hard disk drive, an optical disk drive, solid-state memory, etc., to store the digital images received from the input device 110. The computer system 120 also has a connection with the server computer 130, such as an Ethernet connection, or any other suitable connection.

The computer system 120 may include proprietary software to allow an end user to generate, edit, manipulate, or create effects to the digital images prior to printing. Although Apple Macintosh computers are popular computer systems utilized in the digital photography industry, any other suitable computer systems, including IBM personal computers (PCs) and compatibles may be utilized. The computer system 120 is typically a computer system that an end user, such as a graphics professional, would normally already possess to receive and process digital images from an input device 110. Software programs, such as Adobe PhotoShop, for example, may be utilized on the computer system 120 to edit, manipulate, or create effects to the digital images. According to an embodiment of the present invention, it is preferable that the digital image files are converted into a proprietary format while on the computer system 120 prior to their transmission to the server computer 130. In one embodiment, the computer system 120 and the server computer 130 may be integrated within a single system as well.

The server computer 130 is connected to at least one printer 140, 142 and to a remote monitoring server 150. In one particular application, the printers 140, 142 may be photo-quality printers adapted to print photo-quality prints from the digital images for use in a photography studio. One example of such a printer is an Epson Stylus Pro 5500 printer, which has a 2880×720 dots-per-inch (DPI) resolution. However, any suitable printer may be utilized. A plurality of printers 140, 142 are preferred so that multiple print jobs may be executed at the same time (i.e., the printers 140, 142 being capable of simultaneous printing). For example, by having a plurality of printers 140, 142 available, multiple print-size media may be printed at the same time from the digital image files received from the server computer 130. Accordingly, the present invention is not limited to only one or two printers connected to the server computer 130.

The server computer 130 also has a connection to the remote monitoring server 150. The connection may be via the Internet, a high-speed modem, or any other suitable connection. The server computer 130 preferably executes customized software provided by a service provider or lessor to assist the remote monitoring server 150 to monitor the server computer 130 and/or the at least one printer 140, 142. The remote monitoring server 150 may monitor a number of conditions remotely, including the operation and status of the server computer 130, the operation and status of the printer(s) 140, 142, the ink levels of each ink cartridge (or the toner levels in each toner cartridge) in each printer 140, 142, the contents (full, empty, type of media, size, etc.) of a print media tray(s) of each printer 140, 142, and the number of print media units printed by each printer 140, 142. The above list of conditions is merely illustrative and is not exhaustive or complete.

A remote monitoring server 150 is provided by, for example, a service provider, a lessor, a contractor, etc. (to be discussed further below). The remote monitoring server 150 may be adapted to automatically monitor conditions at the server computer 130 and the at least one printer 140, 142; to identify performance problems with the server computer 130 and the at least one printer 140, 142; and to maintain and charge an account of the end user for the units of media printed by the at least one printer 140, 142 (e.g., the number of sheets printed for a particular sized print media). The remote monitoring server 150 may also perform diagnostic operations on the server computer 130 and/or the printer(s) 140, 142. For example, the remote monitoring server 150 may track every print job executed, including the name of each digital image file being printed. Therefore, it is possible for the lessor to generate a bill based on the account of the end user that includes a list of all of the digital image file names printed, the time and date of the print out, etc., much like that of a telephone bill listing the telephone numbers of the toll calls made. It is also possible that this type of information may be viewed via the Internet. However, any type of information for billing purposes may be tracked by the remote monitoring server 150 and stored with the account of the end user.

The remote monitoring server 150 is preferably provided by one who has agreed to provide for the installation, maintenance, servicing, and upkeep of the server computer 130, the printer(s) 140, 142, and the printing supplies. Accordingly, an end user and a lessor (who is the entity providing the server computer 130 and the printer(s) 140, 142) enter into a lease-type 5 agreement where the end user pays for possession and minimum use of the leased equipment (i.e., the server computer 130, and the printer(s) 140, 142). The lessor is responsible for maintenance, service, and support of the leased equipment, as well as providing for software updates, and replenishing the printing supplies (e.g., print media and ink). In such a lease-type agreement between the end user and the lessor, the end user is freed from the burden and hassles of ownership and maintenance/service responsibilities, as well as not having to worry about replenishing the printing supplies as they become exhausted. For example, the lessor may require a 36-month term lease agreement with a down payment, and monthly payments thereafter from the end user. The lease agreement may, for example, provide for a payment for a fixed limit of media units to be printed, and/or on a cost-per-print basis (e.g., payment based on the l-s actual number of media units printed each month, or the number beyond a fixed limit).

Preferably, the supply by the lessor of the ink (which may include toner) and print media is included with the lease agreement. Therefore, even if end users decide to substitute their own paper or ink, they still cannot avoid the per-print fee. However, the end users do not need to acquire their paper and ink supplies from the lessor, though. But, because the lease agreement already provides for resupply of these printing supplies, end users would not typically duplicate costs by obtaining their own ink and print media.

Therefore, the lease agreement between the end user and the lessor covers service issues for the server computer 130 and the at least one printer 140, 142. The remote monitoring server 150 is utilized by the lessor to remotely monitor the conditions of the server computer 130 and the printer(s) 140, 142 at the end user so that the lessor is informed as to when maintenance, service, and resupply is required. If the remote monitoring server 150 identifies performance problems on the server computer 130 and/or the printers 140, 142, the remote monitoring server 150 may provide a notice to the lessor, as well as to the end user, of the problem detected. Then, the lessor may work with the end user to resolve the problem, as provided for under the lease agreement. E-mail notifications, telephone calls, pages, U.S. mail letters, etc., regarding a maintenance/service call at the end user's location, providing replacement/loaner printers and/or a replacement computer server, and resupplying ink cartridges and print media, may be utilized.

For example, if the remote monitoring server 150 detects that the ink level in an ink cartridge of one of the printers 140, 142 is getting low, then it may compare the data in the enduser's order profile to determine when an order for a replacement ink cartridge for the printer 140, 142 is due. The end-user order profile may include what supplies the end user has authorized to be automatically resupplied, for example, or any other parameters relating to the maintenance, service, and resupply of the printing system. The order may be automatically placed and shipped to the end user just before the ink cartridge is exhausted. Moreover, the remote monitoring server 150 may also remotely provide updates of software residing on the server computer 130 as new updates or versions become available, as the remote monitoring server 150 may be adapted to monitor the software type and version, for example, of the software installed on the server computer 130.

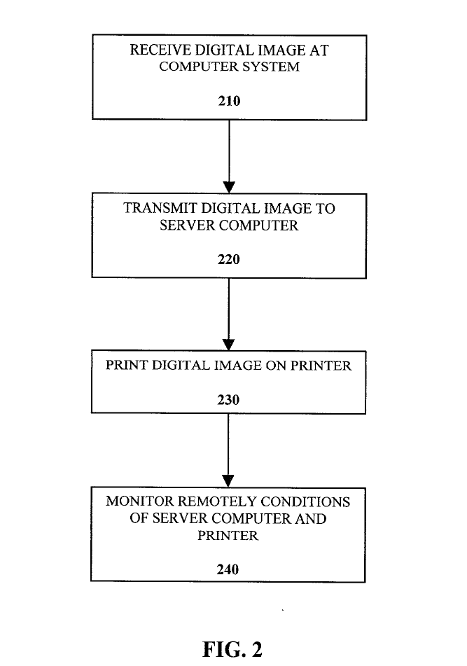

FIG. 2 illustrates a flow chart diagram of printing a digital image by a printing system according to an embodiment of the present invention. A computer system 120 receives 210 a digital image from an input device 110, such as a digital camera. The digital image is transmitted 220 from the computer system 120 to a server computer 130, which has a connection to at least one printer 140, 142 and a connection to a remote monitoring server 150. The printer(s) 140, 142 are adapted to print 230 out the digital image. The remote monitoring server 150, which is operated by a lessor, remotely monitors 240 conditions of at least one of the server computer 130 and the printer(s) 140, 142. The lessor leases out the server computer 130 and the printer(s) 140, 142 to the end user under a lease-type agreement.

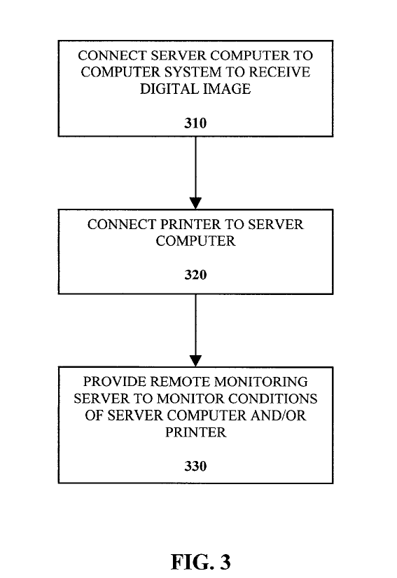

FIG. 3 illustrates a flow chart diagram of configuring a printing system according to an embodiment of the present invention. A server computer 130 is connected 310 to a computer system 120. The server computer 130 receives a digital image from the computer system 120. At least one printer 140, 142 is connected 320 to the server computer 130. The printer(s) 140, 142 is adapted to print out the digital image. A remote monitoring server 150 is provided 330 to remotely monitor the server computer 130 and/or the printer(s) 140, 142. The remote monitoring server 150 is operated by the lessor under a lease-type agreement with the end user, and the lessor leases out the computer server 130 and the printer(s) 140, 142 to the end user and provides for their maintenance, servicing, and upkeep.

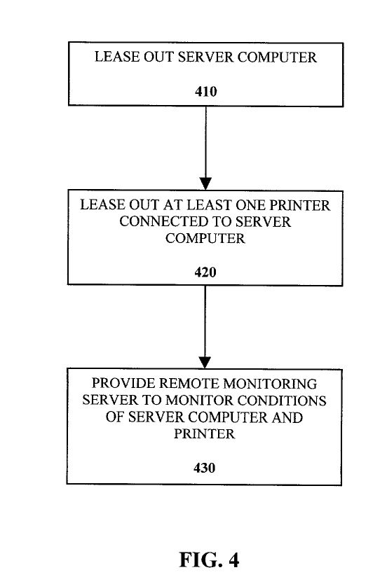

FIG. 4 illustrates a flow chart diagram of providing a printing system under a lease agreement according to an embodiment of the present invention. A lessor leases out 410 a server computer 130 to an end user. The server computer 130 is adapted to receive a digital image from a computer system 120. The lessor also leases out 420 to the end user at least one printer 140, 142 that is connected to the server computer 130. The lessor provides 430 a remote monitoring server 150 having a connection with the server computer 130 to remotely monitor the server computer 130 and the printer(s) 140, 142. The lessor operates the remote monitoring server 150 under a lease-type agreement with the end user, and the lessor provides for all of the maintenance, servicing, and upkeep of the server computer 130 and printer(s) 140, 142, and provides for the resupply of the ink and print media to the end user.

The printing system solution of the present invention provides for an automated system that allows end users to print out digital images on printers that are automatically monitored by a 5 service provider. By continuously monitoring the server computer 130 and/or the at least one printer 140, 142, the service provider ensures that the server computer 130 and the at least one printer 140, 142 are in a constant serviceable state to reliably perform print jobs on-demand from the end users, as well as maintaining a record of the number of units printed. Accordingly, the end user is freed from dealing with the hassles of ownership and maintenance of the printing system and need not worry about restocking the supply of ink or print media utilized by the printing system.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A method of providing a printing system under a lease agreement, comprising:
leasing out a server computer, wherein the server computer receives a digital image transmitted from a computer system;
leasing out at least one printer connected to the server computer, wherein the at least one printer prints the digital image; and
providing a remote monitoring server, having a connection with the server computer, to monitor conditions of at least one of the server computer and the at least one printer, wherein the remote monitoring system is operated by a lessor.

2. The method according to claim 1, further including connecting an input device to the computer system to provide the digital image to the computer system.

3. The method according to claim 2, wherein the input device is selected from the group consisting of a scanner, a digital camera, a computer system, and a network.

4. The method according to claim 1, further including providing a storage device within the computer system to store the digital image.

5. The method according to claim 1, further including providing software to the computer system to edit the digital image.

6. The method according to claim 1, further including converting the digital image into a proprietary format prior to transmitting the digital image to the server computer.

7. The method according to claim 1, further including providing updates by the remote monitoring server for software on the server computer.

8. The method according to claim 1, further including servicing at least one of the server computer and the at least one printer based on the conditions monitored by the remote monitoring server.

9. The method according to claim 1, further including maintaining an account based on the conditions monitored by the remote monitoring server.

10. The method according to claim 1, wherein the conditions monitored include at least one of a number of media printed by the at least one printer, a status of the server computer, a status of the at least one printer, and an ink level of an ink cartridge in the at least one printer.

11. The method according to claim 1, further including supplying at least one of ink and print media based on the conditions monitored by the remote monitoring server.

12. The method according to claim 1, wherein the lease agreement covers possession and minimum use of the server computer and the at least one printer by an end user, and supply of ink and print media to the end user by the lessor.

13. A method of printing, comprising:
receiving a digital image at a computer system;
transmitting the digital image to a server computer, wherein the server computer is connected to at least one printer;
monitoring remotely conditions of at least one of the server computer and the at least one printer by a remote monitoring server having a connection with the server computer, wherein the remote monitoring server is operated by a lessor, and the server computer and the at least one printer are leased out to an end user under a lease agreement; and
printing the digital image on the at least one printer.

14. The method according to claim 13, further including storing the digital image on the computer system.

15. The method according to claim 13, further including editing the digital image on the computer system prior to transmitting the digital image to the server computer.

16. The method according to claim 13, further including converting the digital image into a proprietary format prior to transmitting the digital image to the server computer.

17. The method according to claim 13, wherein the digital image is provided to the computer system via an input device.

18. The method according to claim 13, further including providing updates for software on the server computer by the remote monitoring server.

19. The method according to claim 13, further including servicing at least one of the server computer and the at least one printer based on the conditions monitored by the remote monitoring server.

20. The method according to claim 13, further including maintaining an account based on the conditions monitored by the remote monitoring server.

21. The method according to claim 13, wherein the conditions monitored include at least one of a number of media printed by the at least one printer, a status of the server computer, a status of the at least one printer, and an ink level of an ink cartridge in the at least one printer.

22. The method according to claim 13, further including supplying at least one of ink and print media based on the conditions monitored by the remote monitoring server.

23. The method according to claim 13, wherein the lease agreement covers possession and minimum use of the server computer and the at least one printer by the end user, and supply of ink and print media to the end user by the lessor.

24. A printing system, comprising:
a computer system to receive a digital image;
a server computer, connected to the computer system, to receive the digital image transmitted from the computer system;
at least one printer connected to the server computer to print the digital image; and
a remote monitoring server, having a connection with the server computer, to monitor conditions of at least one of the server computer and the at least one printer, wherein the remote monitoring server is operated by a lessor, and the server computer and the at least one printer are leased out to an end user under a lease agreement.

25. The printing system according to claim 24, further including an input device to provide the digital image to the computer system.

26. The printing system according to claim 25, wherein the input device is selected from the group consisting of a scanner, a digital camera, a computer system, and a network.

27. The printing system according to claim 24, wherein the computer system and the server computer reside within a single system.

28. The printing system according to claim 24, wherein the computer system includes a storage device to store the digital image.

29. The printing system according to claim 24, wherein the computer system includes software to edit the digital image.

30. The printing system according to claim 24, wherein the computer system converts the digital image into a proprietary format prior to transmitting the digital image to the server computer.

31. The printing system according to claim 24, wherein the remote monitoring server is further adapted to provide updates for software on the server computer.

32. The printing system according to claim 24, wherein at least one of the server computer and the at least one printer are serviced based on the conditions monitored by the remote monitoring server.

33. The printing system according to claim 24, wherein an account is maintained based on the conditions monitored by the remote monitoring server.

34. The printing system according to claim 24, wherein the conditions monitored include at least one of a number of media printed by the at least one printer, a status of the server computer, a status of the at least one printer, and an ink level of an ink cartridge in the at least one printer.

35. The printing system according to claim 24, wherein the lease agreement covers possession and minimum use of the server computer and the at least one printer by the end user, and supply of ink and print media to the end user by the lessor.

36. A printing system, comprising:
a server computer to receive a digital image transmitted from a computer system;
at least one printer connected to the server computer to print the digital image; and
a remote monitoring server, having a connection with the server computer, to monitor conditions of at least one of the server computer and the at least one printer, wherein the remote monitoring server is operated by a lessor, and the server computer and the at least one printer are leased out to an end user under a lease agreement.

37. The printing system according to claim 36, further including an input device to provide the digital image to the computer system.

38. The printing system according to claim 37, wherein the input device is selected from the group consisting of a scanner, a digital camera, a computer system, and a network.

39. The printing system according to claim 36, wherein the computer system and the server computer reside within a single system.

40. The printing system according to claim 36, wherein the remote monitoring server is further adapted to provide updates for software on the server computer.

41. The printing system according to claim 36, wherein at least one of the server computer and the at least one printer are serviced based on the conditions monitored by the remote monitoring server.

42. The printing system according to claim 36, wherein an account is maintained based on the conditions monitored by the remote monitoring server.

43. The printing system according to claim 36, wherein the conditions monitored include at least one of a number of media printed by the at least one printer, a status of the server computer, a status of the at least one printer, and an ink level of an ink cartridge in the at least one printer.

44. The printing system according to claim 36, wherein the lease agreement covers possession and minimum use of the server computer and the at least one printer by the end user, and supply of ink and print media to the end user by the lessor.

45. A method of configuring a printing system, comprising:
connecting a server computer to a computer system, wherein the server computer receives a digital image transmitted from the computer system;
connecting at least one printer to the server computer, wherein the at least one printer prints the digital image; and
providing a remote monitoring server, having a connection with the server computer, to monitor conditions of at least one of the server computer and the at least one printer, wherein the remote monitoring server is operated by a lessor, and the server computer and the at least one printer are leased out to an end user under a lease agreement.

46. The method according to claim 45, further including connecting an input device to the computer system to provide the digital image to the computer system.

47. The method according to claim 46, wherein the input device is selected from the group consisting of a scanner, a digital camera, a computer system, and a network.

48. The method according to claim 45, further including providing a storage device 2 within the computer system to store the digital image.

49. The method according to claim 45, further including providing software to the computer system to edit the digital image.

50. The method according to claim 45, wherein the computer system converts the digital image into a proprietary format prior to transmitting the digital image to the server computer.

51. The method according to claim 45, further including providing updates by the remote monitoring server for software on the server computer.

52. The method according to claim 45, further including servicing at least one of the server computer and the at least one printer based on the conditions monitored by the remote monitoring server.

53. The method according to claim 45, further including maintaining an account based on the conditions monitored by the remote monitoring server.

54. The method according to claim 45, wherein the conditions monitored include at least one of a number of media printed by the at least one printer, a status of the server computer, a status of the at least one printer, and an ink level of an ink cartridge in the at least one printer.

55. The method according to claim 45, further including supplying at least one of ink and print media based on the conditions monitored by the remote monitoring server.

56. The method according to claim 45, wherein the lease agreement covers possession and minimum use of the server computer and the at least one printer by the end user, and supply of ink and print media to the end user by the lessor.
